(19) United States
(12) Patent Application Publication
(10) Pub. No.: US 2026/0280749 A1
(43) Pub. Date: Sep. 17, 2026

(54) NEW PADDING SCHEMES IN WIRELESS COMMUNICATIONS

(71) Applicant: MEDIATEK INC., Hsinchu City (TW)

(72) Inventors: Yi-Hsiang LAI, Hsinchu City (TW); Cheng-Yi CHANG, Hsinchu City (TW); Kai Ying LU, San Jose, CA (US); Chia-Ming CHANG, Hsinchu City (TW); Kun-Sheng HUANG, Hsinchu City (TW)

(21) Appl. No.: 19/168,289

(22) PCT Filed: Nov. 29, 2024
(86) PCT No.: PCT/CN2024/135477

§ 371 Date: Sep. 23, 2025

Related U.S. Application Data
(60) Provisional application No. 63/604,936, filed on Dec. 1, 2023.
(60) Provisional application No. 63/617,457, filed on Jan. 4, 2024.

(51) Int. Cl. H04L 1/00; H04W 74/00; H04W 74/0816

(52) U.S. Cl. CPC H04L 1/0008; H04W 74/002; H04W 74/0816

(57) ABSTRACT

Techniques pertaining to new padding schemes in wireless communications are described. An apparatus (e.g., a station (STA)) performs a wireless communication by: (a) generating and transmitting a physical-layer protocol data unit (PPDU); or (b) receiving and processing the PPDU. The PPDU comprises post-frame check sequence (post-FCS) padding after a frame check sequence (FCS) field of the PPDU.

### CROSS REFERENCE TO RELATED PATENT APPLICATION

The present disclosure is part of a non-provisional patent application claiming the priority benefit of U.S. Provisional Patent Application Nos. 63/604,936 and 63/617,457, filed 1 Dec. 2023 and 4 Jan. 2024, respectively, the contents of which herein being incorporated by reference in their entirety.

### TECHNICAL FIELD

The present disclosure is generally related to wireless communications and, more particularly, to new padding schemes in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) under the Institute of Electrical and Electronics Engineers (IEEE) 802.11 specifications, a Wi-Fi device may require extra processing time to reconfigure its radio due to application purpose or protocol requirements. In the current IEEE 802.11 standard, trigger frame medium access control (MAC) padding is proposed to provide more MAC processing time for a non-access point (non-AP) station (STA) and/or multi-link device (MLD). Packet extension is also proposed to provide more physical-layer (PHY) processing time for High-Efficiency (HE)/Extremely-High-Throughput (EHT) PHY protocol data unit (PPDU) format.

However, in a current trigger frame packet, a frame check sequence (FCS) field is after padding. This would result in the loss of the original intention of padding, which is to occupy time and allow a receiver to have enough time to configure its new setting. If a STA starts to configure its new setting during the padding time but eventually encounters an FCS error, the entire progress will become useless. Moreover, a trigger frame is not defined under the current IEEE 802.11 standard for a non-AP to provide more processing time to its peer STA. Additionally, there is no packet extension (or a very limited duration) to provide more PHY processing time for orthogonal frequency-division multiplexing (OFDM)/non-High-Throughput (non-HT) duplicated/High-Throughput (HT)/Very-High-Throughput (VHT) PPDU format. Moreover, there is no other control frame (e.g., request-to-send (RTS) and clear-to-send (CTS)) that has padding time to provide more processing time for a target receiver. Therefore, there is a need for a solution of new padding schemes in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods, and apparatuses pertaining to new padding schemes in wireless communications. It is believed that various schemes proposed herein may address or otherwise alleviate these aforementioned issue(s). For instance, under various proposed schemes of the present disclosure, post-FCS padding may be utilized to introduce extra processing time for a Wi-Fi control frame. The post-FCS padding may include, for example, padding of a dummy pattern and/or padding of useful information (e.g., information useful to a recipient).

In one aspect, a method may involve performing a wireless communication by: (a) generating and transmitting a PPDU; or (b) receiving and processing the PPDU. The PPDU may include post-FCS padding after an FCS field of the PPDU.

In another aspect, an apparatus may include a transceiver configured to communicate wirelessly and a processor coupled to the transceiver. The processor may be configured to perform a wireless communication by: (a) generating and transmitting a PPDU; or (b) receiving and processing the PPDU. The PPDU may include post-FCS padding after an FCS field of the PPDU.

It is noteworthy that, although the description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example scenario in which various proposed schemes in accordance with the present disclosure may be implemented.

FIG. 7 is a diagram of an example scenario in which various proposed schemes in accordance with the present disclosure may be implemented.

FIG. 8 is a diagram of an example scenario in which various proposed schemes in accordance with the present disclosure may be implemented.

FIG. 9 is a diagram of an example scenario in which various proposed schemes in accordance with the present disclosure may be implemented.

FIG. 10 is a diagram of an example scenario in which various proposed schemes in accordance with the present disclosure may be implemented.

FIG. 11 is a block diagram of an example communication system under a proposed scheme in accordance with the present disclosure.

FIG. 12 is a flowchart of an example process under a proposed scheme in accordance with the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to new padding schemes in wireless communications. According to the present disclosure, a number of possible solutions may be implemented separately or jointly. That is, although these possible solutions may be described below separately, two or more of these possible solutions may be implemented in one combination or another.

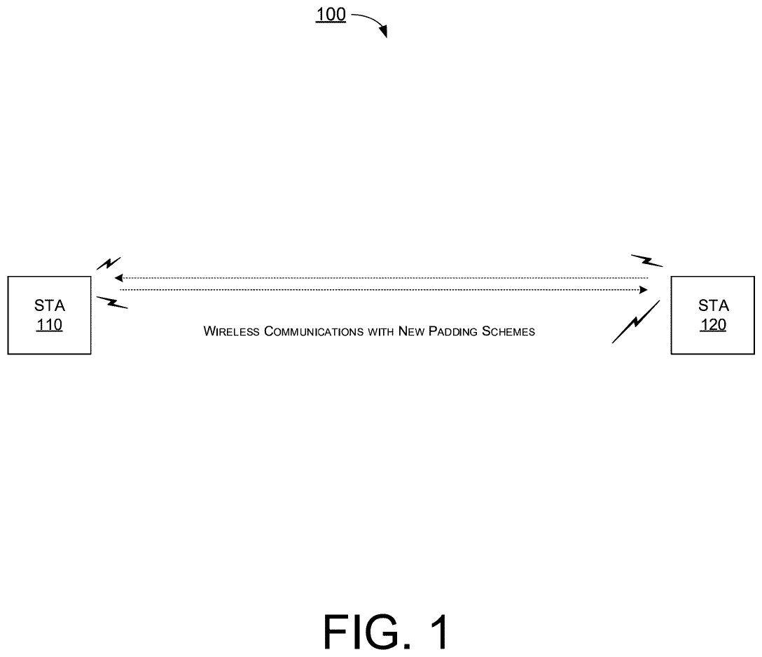

FIG. 1 illustrates an example network environment 100 in which various solutions and schemes in accordance with the present disclosure may be implemented. FIG. 1-FIG. 12 illustrate examples of implementation of various proposed schemes in network environment 100 in accordance with the present disclosure. The following description of various proposed schemes is provided with reference to FIG. 1-FIG. 12.

Referring to FIG. 1, network environment 100 may include at least a first STA (STA 110) and a second STA (STA 120). Either STA 110 or STA 120 may function as an access point (AP) STA or a non-AP STA. While there may be additional STAs involved in network environment 100 under one or more schemes proposed herein, for simplicity only two STAs (STA 110 and STA 120) are shown in FIG. 1 with the understanding that additional STAs may be involved (e.g., additional non-AP STAs participating in ranging sessions under the proposed schemes). Each of STA 110 and STA 120 may be configured to implement various proposed schemes in accordance with the present disclosure as described below. For instance, STA 110 may function as an initiator and STA 120 may function as a responder, or vice versa. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under various proposed schemes in accordance with the present disclosure, post-FCS padding may be utilized as new padding schemes. Under the proposed schemes, post-FCS padding may add extra processing time for Wi-Fi devices (e.g., STA 110 and STA 120) and for any PPDU format. That is, post-FCS padding may provide a receiver with more time by FCS check with the original FCS and to use the rest of time to adjust its radio configurations. Under the proposed schemes, post-FCS padding may not be limited by the control frame format. For instance, current operations requiring additional processing time within a control frame may necessitate the use of trigger frames to incorporate padding into the control frame. Moreover, post-FCS padding may allow usage of the padding mechanism in RTS, power save polling (PS-poll) or other non-HT/non-HT duplicated control frame(s). Under the proposed schemes, post-FCS padding may not be limited by an initiator in a frame exchange (e.g., STA 110 or STA 120), and the initiator may be an AP, soft-AP or non-AP STA.

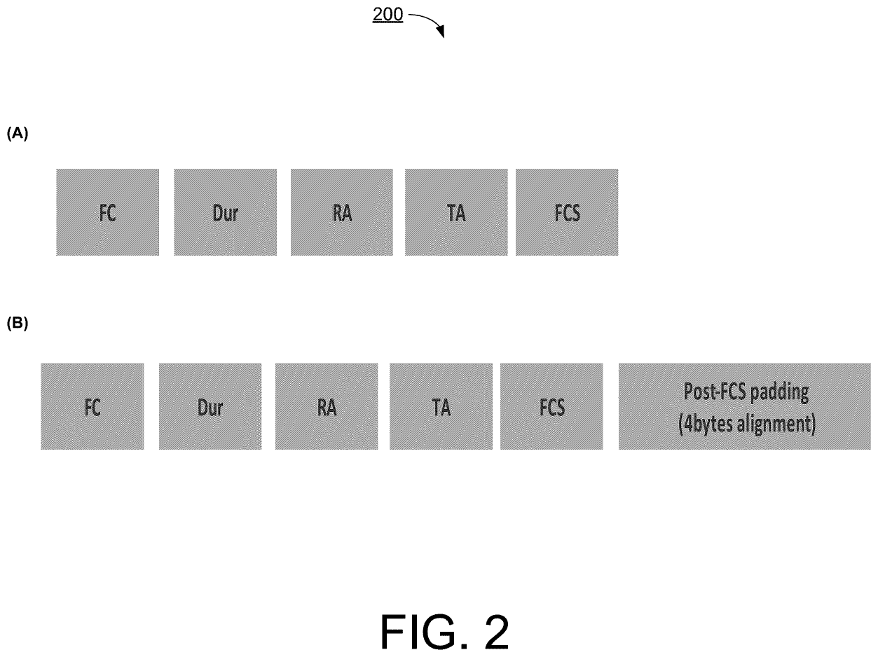

FIG. 2 illustrates an example design 200 under a proposed scheme in accordance with the present disclosure. Part (A) of FIG. 2 shows a frame as-is without post-FCS padding under the proposed scheme. Part (B) of FIG. 2 shows the frame with post-FCS padding under the proposed scheme. Referring to FIG. 2, under the proposed scheme, post-FCS padding may be utilized to add a dummy pattern after an original FCS in a frame. For instance, the dummy pattern may be added after the FCS field of an RTS or CTS frame. The frame with the post-FCS padding may be contained in any PPDU format, especially for non-HT PPDUs and non-HT duplicated PPDUs. A peer STA may use the post-FCS padding duration in a PPDU to update its transceiver parameters. The post-FCS padding may be configured with 4-byte assignment.

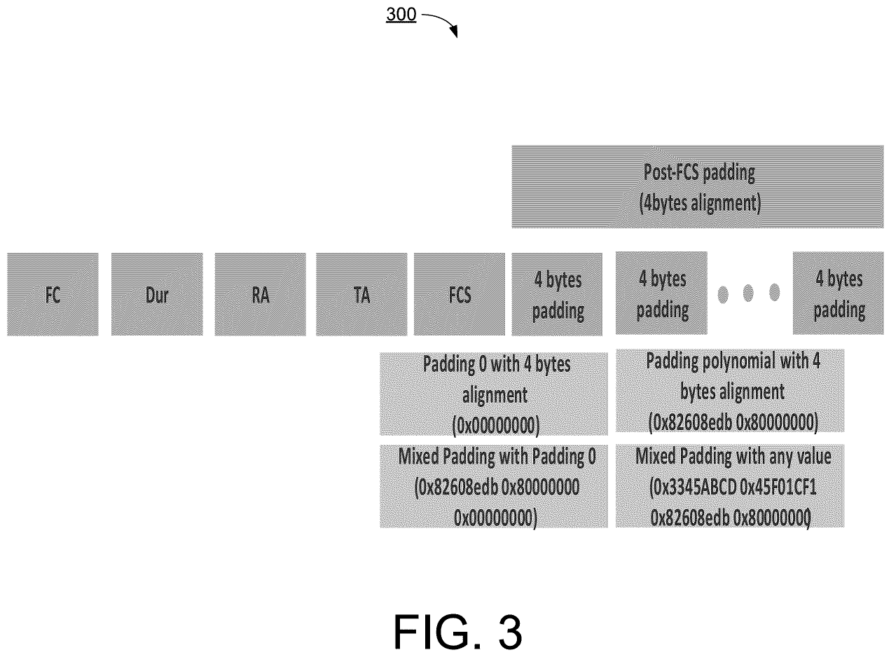

FIG. 3 illustrates an example design 300 under a proposed scheme in accordance with the present disclosure. Under the proposed scheme, there may be several (e.g., three) variants of a post-FCS padding pattern. In a first variant, post-FCS padding may involve padding any information using a multiple of 4-byte alignment after FCS. For instance, the padding may include a zero value with one or more groups of 4 bytes for alignment. Alternatively, the padding may include a random value with one or more groups of 4 bytes for alignment. In a second variant, post-FCS padding may involve padding multiple polynomials and each polynomial may pass the FCS check with a 4-byte alignment after FCS. For instance, CRC32-MPEG-2 may be used as a CRC32 polynomial function in a Wi-Fi system. In a third variant, a mixture of both the first variant and the second variant may be utilized. For instance, an unconstrained, arbitrary combination of any values with polynomials may be utilized while maintaining 4-byte alignment integrity and may pass FCS checking.

Under a proposed scheme in accordance with the present disclosure, the duration of post-FCS padding may be negotiated among STAs (e.g., between STA 110 and STA 120). For instance, the padding duration may be longer than {0, 8, 16, 32, 128, 256} microseconds for a specific peer STA. The count of total bytes of the post-FCS padding length may be determined based on varying padding duration and transmission rate. The L_LENGHT field in the preamble of a PPDU may be modified accordingly to meet the specific requirement.

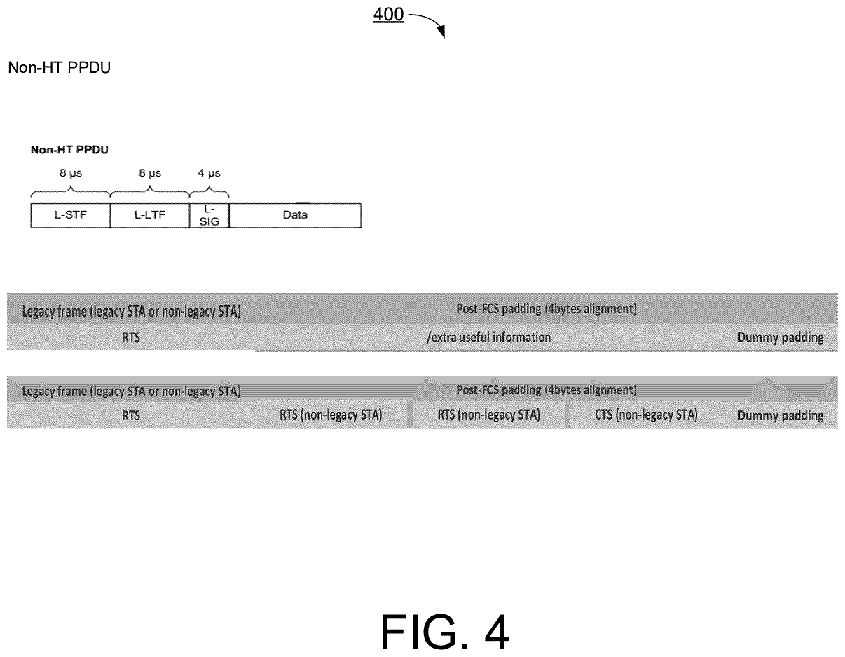

FIG. 4 illustrates an example design 400 under a proposed scheme in accordance with the present disclosure. Referring to FIG. 4, in addition to padding a dummy pattern in post-FCS padding, useful information (e.g., information useful to a recipient of the PPDU with post-FCS padding) may be added in the post-FCS padding. This mechanism may convey a diverse range of information such as, for example and not limited to, bandwidth, power specifications, number of spatial streams, data rates, and subband positions. Essentially, padding useful information may provide a way to transmit any parameters that the initiator deems necessary to communicate to a responder. The extra useful information may include aggregated Wi-Fi packets such as, for example and not limited to, RTS or multi-user RTS (MU-RTS) to non-legacy STA(s). The RTS (for non-legacy STA(s)) may be used as the initial control PPDU for Enhanced Multilink Single Radio (EMLSR) and/or Dynamic Subband Operation (DSO). The term “non-legacy STA” herein refers to a STA that supports the behavior to correctly transmit and receive a PPDU with post-FCS padding under the various proposed schemes in accordance with the present disclosure.

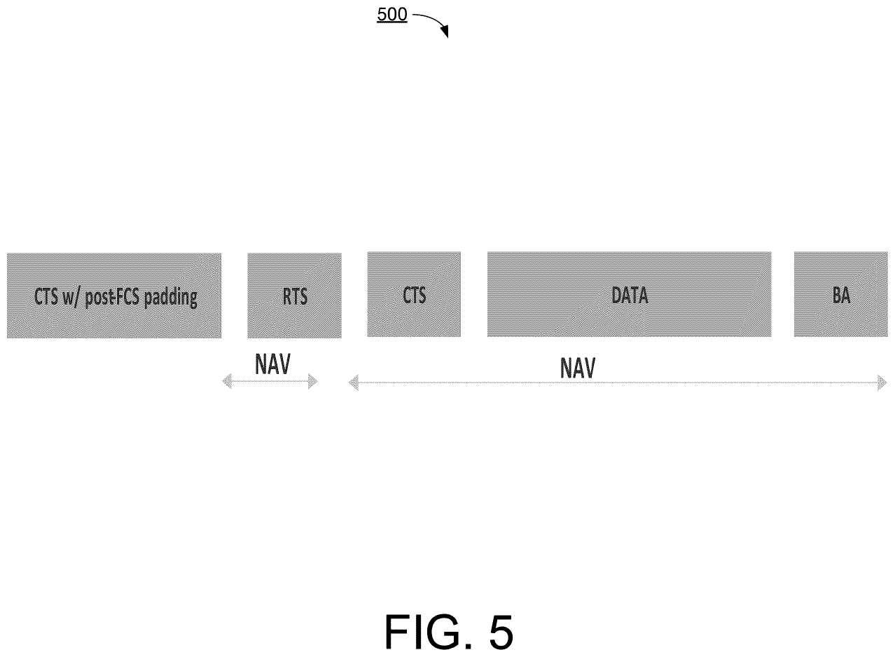

FIG. 5 illustrates an example design 500 under a proposed scheme in accordance with the present disclosure. Under the proposed scheme, to enhance backward compatibility with legacy STAs, a transmission opportunity (TXOP) initiator may transmit an initial frame (e.g., CTS-to-Self frame) with a short network allocation vector (NAV) to cover the next transmit frame (e.g., an RTS or data frame), as shown in FIG. 5. In case that a legacy STA cannot decode the new CTS frame with post-FCS padding, the NAV may be set correctly by the next transmit frame (e.g., RTS). In scenarios where legacy STAs are unable to decode the CTS frames with post-FCS padding, the NAV may still be accurately set through frames in subsequent transmissions, such as RTS frames.

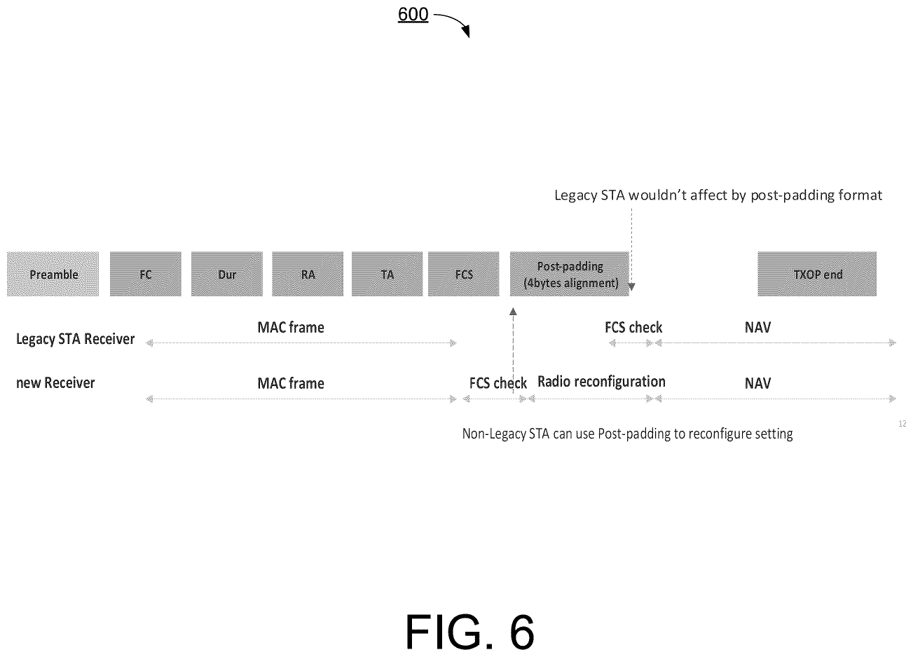

FIG. 6 illustrates an example scenario 600 of control frame post-FCS padding in which various proposed schemes in accordance with the present disclosure may be implemented. Scenario 600 may pertain to a power saving scenario. Referring to FIG. 6, in scenario 600, a STA (e.g., STA 110) may use a control frame to allow or otherwise trigger a peer STA (e.g., STA 120) to wake up (from a power-saving mode). The initiating/trigger STA may be an AP, soft-AP or non-AP STA. This mechanism may be utilized to switch from a low power mode to an active mode, and vice versa. Similarly, this mechanism may be utilized to switch from a low capability mode to a high capability mode, and vice versa. The control frame may have post-FCS padding to provide the switching time at which to switch from one mode to the other. Moreover, the control frame that triggers mode switching may be an initial control frame (ICF) and/or a control response frame.

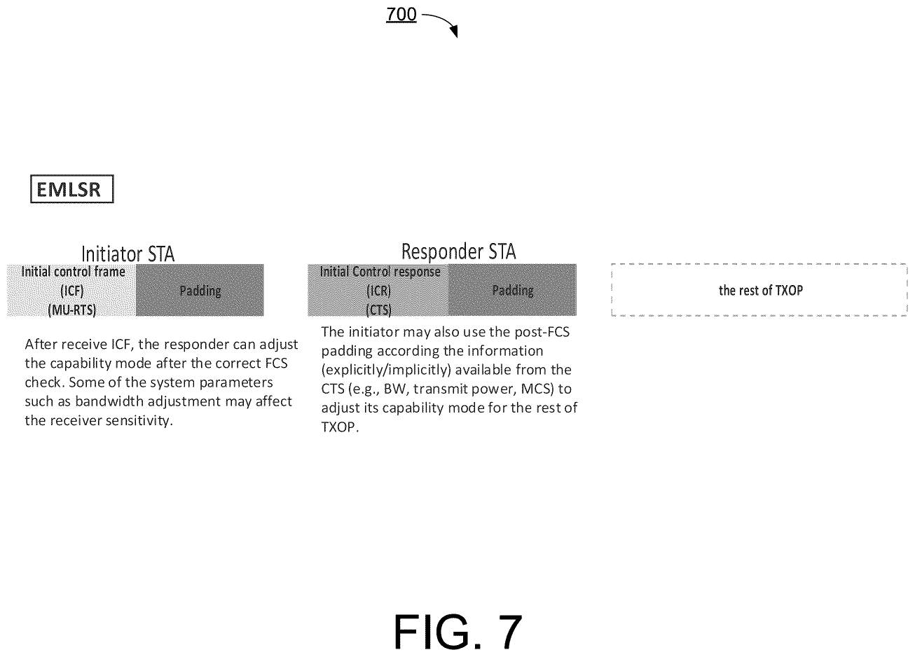

FIG. 7 illustrates an example scenario 700 of control frame post-FCS padding in which various proposed schemes in accordance with the present disclosure may be implemented. Scenario 700 may pertain to an EMLSR/DSO scenario. In scenario 700, a STA (e.g., STA 110) may use a control frame to allow or otherwise trigger a peer STA (e.g., STA 120) to perform mode switching. The initiating/trigger STA may be an AP, soft-AP or non-AP STA. This mechanism may be utilized to switch between different links or different subbands. The control frame may have post-FCS padding to provide the switching time at which to switch from one mode to the other. Moreover, the control frame that triggers mode switching may be an initial control frame (ICF) and/or a control response frame. Referring to FIG. 7, after receiving the ICF, the responder STA may adjust its capability mode after a correct FCS check. Some of the system parameters, such as bandwidth adjustment, may affect a receiver's sensitivity. Moreover, the initiator STA may also use the post-FCS padding according to the information explicitly and/or implicitly available from a CTS (e.g., bandwidth, transmit power, modulation and coding scheme (MCS)) to adjust its capability mode for the rest of the TXOP.

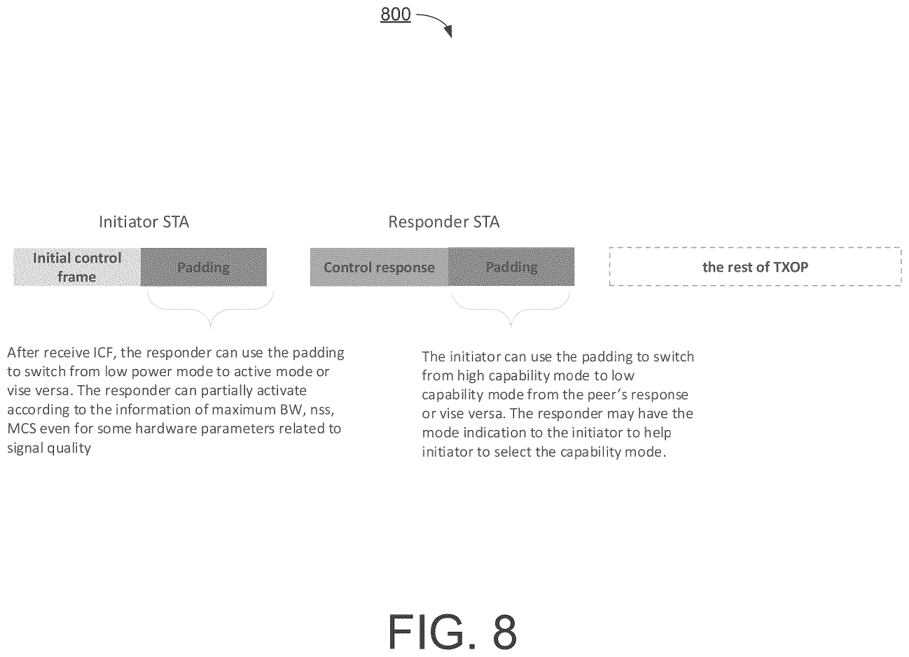

FIG. 8 illustrates an example scenario 800 of control frame post-FCS padding in which various proposed schemes in accordance with the present disclosure may be implemented. Scenario 800 may pertain to a peer-to-peer (P2P) or Tunneled Direct Link Setup (TDLS) or independent basic service set (BSS) scenario. In scenario 800, a STA (e.g., STA 110) may use a control frame to allow or otherwise trigger a peer STA (e.g., STA 120) to perform mode switching. The initiating/trigger STA may be a non-AP STA. This mechanism may be utilized to switch from a low power mode to an active mode, and vice versa. Similarly, this mechanism may be utilized to switch from a low capability mode to a high capability mode, and vice versa. The control frame may have post-FCS padding to provide the switching time at which to switch from one mode to the other. Moreover, the control frame that triggers mode switching may be an initial control frame (ICF) and/or a control response frame. Referring to FIG. 8, after receiving the ICF, the responder STA may use the padding to switch from a low power mode to an active mode or vice versa. The responder STA may partially activate according to the information of a maximum bandwidth, number of spatial streams (Nss), MCS, and/or some hardware parameters related to a signal quality. The initiator STA may use the padding to switch from a high capability mode to a low capability mode from the peer's response or vice versa. The responder STA may provide a mode indication to the initiator STA to assist the initiator STA in selecting the capability mode.

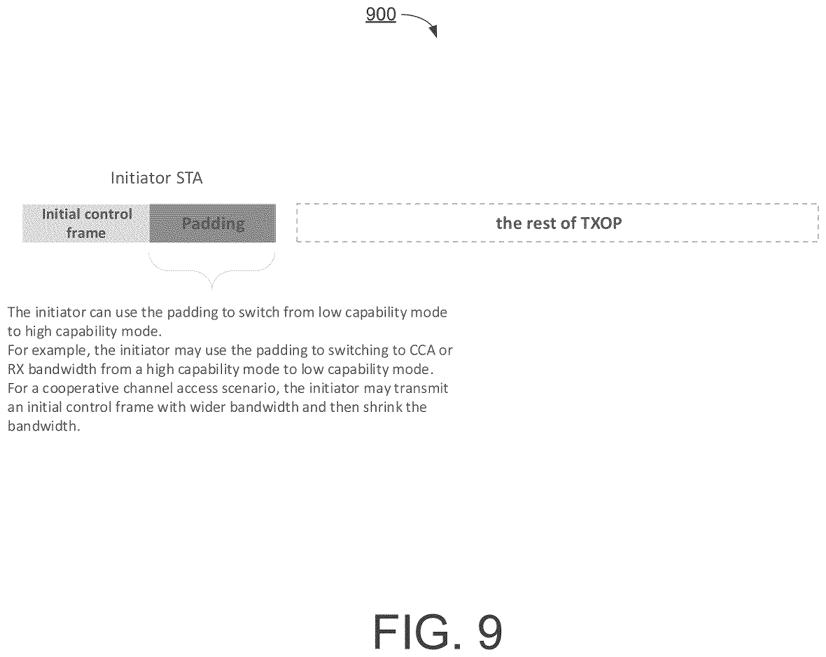

FIG. 9 illustrates an example scenario 900 of control frame post-FCS padding in which various proposed schemes in accordance with the present disclosure may be implemented. In scenario 900, a STA (e.g., STA 110 or STA 120) obtaining a TXOP may transmit a control frame with post-FCS padding to allow itself to switch from one mode (e.g., low power mode or low capability mode) to another (e.g., active mode or high capability mode), or vice versa, during the post-FCS period. The STA may be an AP, soft-AP or non-AP STA. Referring to FIG. 9, the initiator STA may use the padding to switch from a low capability mode to a high capability mode. For instance, the initiator STA may use the padding to switch to channel clear access (CCA) or receiver (Rx) bandwidth from a high capability mode to a low capability mode. For a cooperative channel access scenario, the initiator may transmit an initial control frame with a wider bandwidth and then shrink the bandwidth.

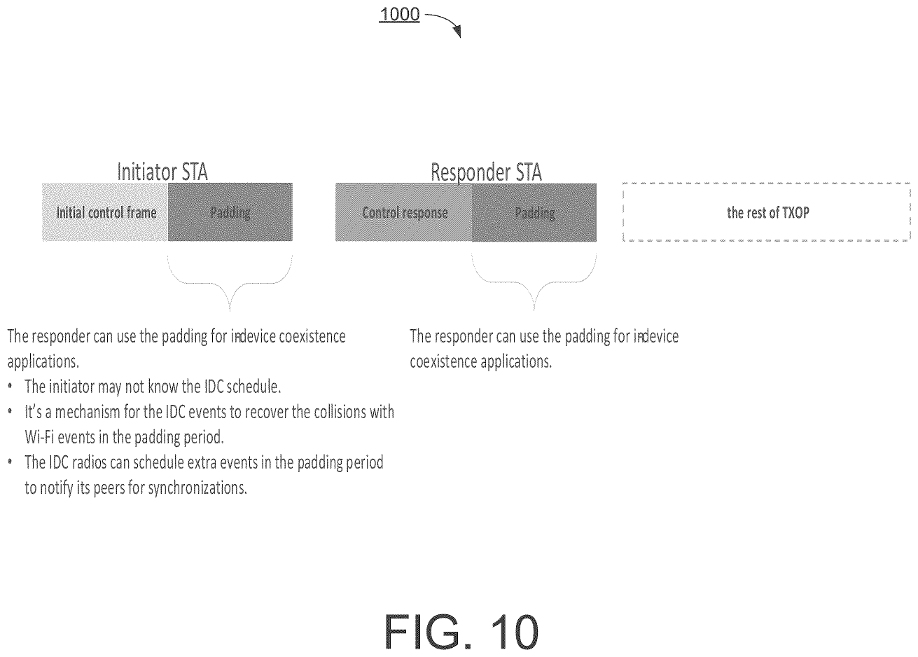

FIG. 10 illustrates an example scenario 1000 of control frame post-FCS padding in which various proposed schemes in accordance with the present disclosure may be implemented. In scenario 1000, a STA (e.g., STA 110 or STA 120) may use a control frame to allow itself or other STAs to reconfigure other radios and/or to signal or communicate by other radios for in-device coexistence (e.g., Bluetooth, Ultra-Wide Bandwidth (UWB) or out-of-band activities) purposes. Some more information may be specified in the initial control frame for in-device coexistence applications (e.g., TXOP information for in-device coexistence scheduling). Referring to FIG. 10, the responder STA may use the padding for in-device coexistence (IDC) applications. The initiator STA may not know the IDC schedule. This may be a mechanism for the IDC events to recover collisions with Wi-Fi events in the padding period. The IDS radios may schedule extra events in the padding period to notify its peers for synchronization. The responder STA may use the padding for IDC applications.

### Illustrative Implementations

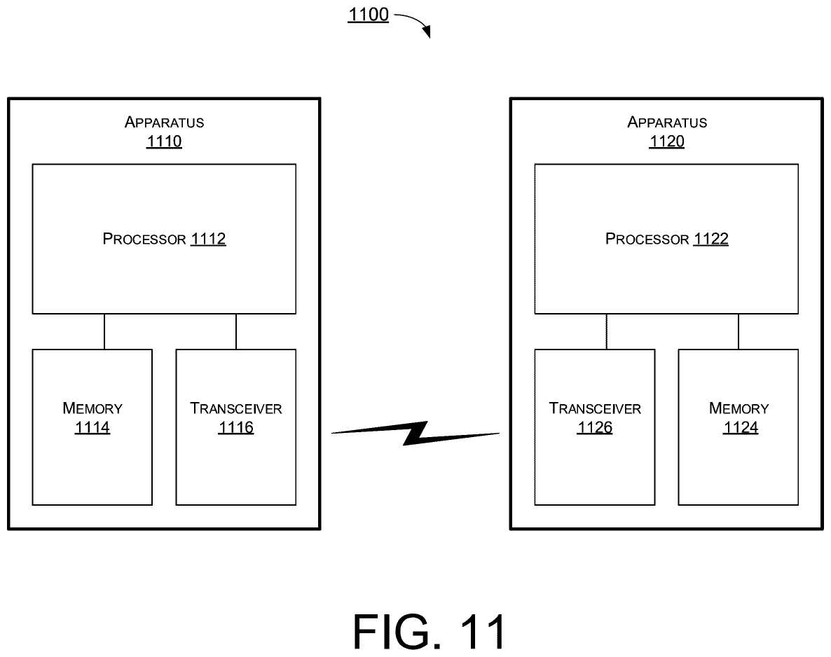

FIG. 11 illustrates an example system 1100 having at least an example apparatus 1110 and an example apparatus 1120 in accordance with an implementation of the present disclosure. Each of apparatus 1110 and apparatus 1120 may perform various functions to implement schemes, techniques, processes and methods described herein pertaining to new padding schemes in wireless communications, including the various schemes described above with respect to various proposed designs, concepts, schemes, systems and methods described above as well as processes described below. For instance, apparatus 1110 may be implemented in STA 110 and apparatus 1120 may be implemented in STA 120, or vice versa.

Each of apparatus 1110 and apparatus 1120 may be a part of an electronic apparatus, such as a portable or mobile apparatus, a wearable apparatus, a wireless communication apparatus or a computing apparatus. When implemented in a STA, each of apparatus 1110 and apparatus 1120 may be implemented in a smartphone, a smart watch, a personal digital assistant, a digital camera, or a computing equipment such as a tablet computer, a laptop computer or a notebook computer. Each of apparatus 1110 and apparatus 1120 may also be a part of a machine type apparatus, which may be an IoT apparatus such as an immobile or a stationary apparatus, a home apparatus, a wire communication apparatus or a computing apparatus. For instance, each of apparatus 1110 and apparatus 1120 may be implemented in a smart thermostat, a smart fridge, a smart door lock, a wireless speaker or a home control center. When implemented in or as a network apparatus, apparatus 1110 and/or apparatus 1120 may be implemented in a network node, such as an AP in a WLAN.

In some implementations, each of apparatus 1110 and apparatus 1120 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1110 and apparatus 1120 may be implemented in or as a controller/initiator or a controlee/responder. Each of apparatus 1110 and apparatus 1120 may include at least some of those components shown in FIG. 11 such as a processor 1112 and a processor 1122, respectively, for example. Each of apparatus 1110 and apparatus 1120 may further include one or more other components not pertinent to the proposed scheme of the present disclosure (e.g., internal power supply, display device and/or user interface device), and, thus, such component(s) of apparatus 1110 and apparatus 1120 are neither shown in FIG. 11 nor described below in the interest of simplicity and brevity.

In one aspect, each of processor 1112 and processor 1122 may be implemented in the form of one or more single-core processors, one or more multi-core processors, one or more RISC processors or one or more CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including those pertaining to new padding schemes in wireless communications in accordance with various implementations of the present disclosure.

In some implementations, apparatus 1110 may also include a transceiver 1116 coupled to processor 1112. Transceiver 1116 may include a transmitter capable of wirelessly transmitting and a receiver capable of wirelessly receiving data. In some implementations, apparatus 1120 may also include a transceiver 1126 coupled to processor 1122. Transceiver 1126 may include a transmitter capable of wirelessly transmitting and a receiver capable of wirelessly receiving data. It is noteworthy that, although transceiver 1116 and transceiver 1126 are illustrated as being external to and separate from processor 1112 and processor 1122, respectively, in some implementations, transceiver 1116 may be an integral part of processor 1112 as a system on chip (SoC) and/or transceiver 1126 may be an integral part of processor 1122 as a SoC.

In some implementations, apparatus 1110 may further include a memory 1114 coupled to processor 1112 and capable of being accessed by processor 1112 and storing data therein. In some implementations, apparatus 1120 may further include a memory 1124 coupled to processor 1122 and capable of being accessed by processor 1122 and storing data therein. Each of memory 1114 and memory 1124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1114 and memory 1124 may include a type of read-only memory (ROM) such as mask ROM, programmable ROM (PROM), erasable programmable ROM (EPROM) and/or electrically erasable programmable ROM (EEPROM). Alternatively, or additionally, each of memory 1114 and memory 1124 may include a type of non-volatile random-access memory (NVRAM) such as flash memory, solid-state memory, ferroelectric RAM (FeRAM), magnetoresistive RAM (MRAM) and/or phase-change memory.

Each of apparatus 1110 and apparatus 1120 may be a communication entity capable of communicating with each other using various proposed schemes in accordance with the present disclosure. For illustrative purposes and without limitation, a description of capabilities of apparatus 1110 or apparatus 1120, as STA 110 and STA 120, respectively, is provided below in the context of example process 1200. It is noteworthy that, although a detailed description of capabilities, functionalities and/or technical features of either of apparatus 1110 and apparatus 1120 is provided below, the same may be applied to the other of apparatus 1110 and apparatus 1120 although a detailed description thereof is not provided solely in the interest of brevity. It is also noteworthy that, although the example implementations described below are provided in the context of WLAN, the same may be implemented in other types of networks.

### Illustrative Processes

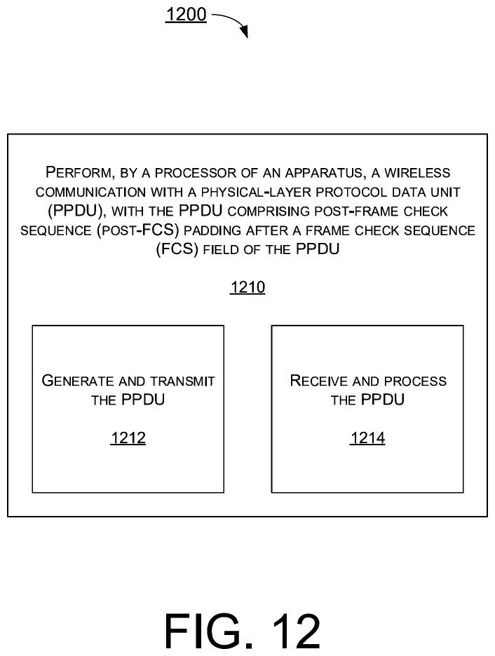

FIG. 12 illustrates an example process 1200 in accordance with an implementation of the present disclosure. Process 1200 may represent an aspect of implementing various proposed designs, concepts, schemes, systems, and methods described above. More specifically, process 1200 may represent an aspect of the proposed concepts and schemes pertaining to new padding schemes in wireless communications. Process 1200 may include one or more operations, actions, or functions as illustrated by one or more of blocks/subblocks. Although illustrated as discrete blocks, various blocks of process 1200 may be divided into additional blocks, combined into fewer blocks, or eliminated, depending on the desired implementation. Moreover, the blocks/sub-blocks of process 1200 may be executed in the order shown in FIG. 12 or, alternatively, in a different order. Furthermore, one or more of the blocks/sub-blocks of process 1200 may be executed repeatedly or iteratively. Process 1200 may be implemented by or in apparatus 1110 and apparatus 1120 as well as any variations thereof. Solely for illustrative purposes and without limiting the scope, process 1200 is described below in the context of apparatus 1110 and implemented in or as a ranging controlee/responder (e.g., a wireless communication device) and apparatus 1120 implemented in or as ranging controller/initiator of a wireless network in network environment 100, or vice vera, in accordance with one or more of IEEE 802.15.4 standards. Process 1200 may begin at block 1210.

At 1210, process 1200 may include processor 1112 of apparatus 1110 performing, via transceiver 1116, a wireless communication with a PPDU. The PPDU may include post-FCS padding after an FCS field of the PPDU. Operations of the wireless communication may be represented by 1212 and 1214.

At 1212, process 1200 may involve processor 1112 generating and transmitting the PPDU.

At 1214, process 1200 may involve processor 1112 receiving and processing the PPDU.

In some implementations, the PPDU may include a non-HT PPDU or a non-HT duplicated PPDU.

In some implementations, the PPDU may include a control frame (e.g., an RTS frame, a CTS frame, a MU-RTS frame or a CTS-to-self frame).

In some implementations, the post-FCS padding may include a padding of a dummy pattern or information useful to a recipient of the PPDU, or both, padded after the FCS field. In some implementations, the information useful to the recipient of the PPDU may include information on a bandwidth, a power specification, a number of spatial streams, a data rate, a subband position, or a combination thereof. Alternatively, the information useful to the recipient of the PPDU may include aggregated packets directed to multiple STAs supporting one or more PPDUs with post-FCS padding.

In some implementations, the post-FCS padding may include a padding of any information comprising a zero value or a random value with one or more groups of 4 bytes facilitating a 4-byte alignment.

In some implementations, the post-FCS padding may include a padding of multiple polynomials, each of which passing a FCS check, with one or more groups of 4 bytes facilitating a 4-byte alignment.

In some implementations, a duration of the post-FCS padding may be negotiated among two or more STAs.

In some implementations, the PPDU may be transmitted as part of a CTS-to-self frame with an NAV covering a next transmit frame which is an RTS frame or a data frame.

In some implementations, the PPDU may be transmitted as part of a control frame which is an initial control frame or a control response frame that triggers a peer STA to wake up and switch from a low power mode to an active mode or from a low capability mode to a high capability mode. In some implementations, responsive to the performing of the wireless communication comprising receiving and processing the PPDU, process 1200 may additionally involve processor 1112 switching from the low power mode to the active mode or from the low capability mode to the high capability mode. The post-FCS padding may provide time to carry out the switching.

In some implementations, the PPDU may be transmitted as part of a control frame which is an initial control frame or a control response frame that triggers a peer STA to switch between different links or different subbands. In some implementations, responsive to the performing of the wireless communication comprising receiving and processing the PPDU, process 1200 may additionally involve processor 1112 switching between the different links or the different subbands. The post-FCS padding may provide time to carry out the switching.

In some implementations, the PPDU may be transmitted as part of a control frame that allows a STA obtaining a TXOP to allow itself to switch from a low power mode to an active mode or from a low capability mode to a high capability mode. In some implementations, responsive to the performing of the wireless communication comprising generating and transmitting the PPDU, process 1200 may additionally involve processor 1112 switching from the low power mode to the active mode or from the low capability mode to the high capability mode. The post-FCS padding may provide time to carry out the switching.

In some implementations, the PPDU may be transmitted as part of a control frame that allows a STA and its peer STAs to reconfigure one or more radios or communicate by one or more other radios with respect to an IDC purpose. In some implementations, process 1200 may additionally involve processor 1112 reconfiguring the one or more radios or communicating by the one or more other radios with respect to the IDC purpose. The post-FCS padding may provide time to carry out the reconfiguring or communicating.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, a wireless communication by:
generating and transmitting a physical-layer protocol data unit (PPDU); or
receiving and processing the PPDU,
wherein the PPDU comprises post-frame check sequence (post-FCS) padding after a frame check sequence (FCS) field of the PPDU.

2. The method of claim 1, wherein the PPDU comprises a non-High-Throughput (non-HT) PPDU or a non-HT duplicated PPDU.

3. The method of claim 1, wherein the PPDU comprises a control frame.

4. The method of claim 1, wherein the post-FCS padding comprises a padding of a dummy pattern or information useful to a recipient of the PPDU, or both, padded after the FCS field.

5. The method of claim 4, wherein the information useful to the recipient of the PPDU comprises information on a bandwidth, a power specification, a number of spatial streams, a data rate, a subband position, or a combination thereof.

6. The method of claim 4, wherein the information useful to the recipient of the PPDU comprises aggregated packets directed to multiple stations (STAs) supporting one or more PPDUs with post-FCS padding.

7. The method of claim 1, wherein the post-FCS padding comprises a padding of any information comprising a zero value or a random value with one or more groups of 4 bytes facilitating a 4-byte alignment.

8. The method of claim 1, wherein the post-FCS padding comprises a padding of multiple polynomials, each of which passing a FCS check, with one or more groups of 4 bytes facilitating a 4-byte alignment.

9. The method of claim 1, wherein a duration of the post-FCS padding is negotiated among two or more stations (STAs).

10. The method of claim 1, wherein the PPDU is transmitted as part of a clear-to-send (CTS)-to-self frame with a network allocation vector (NAV) covering a next transmit frame which is a request-to-send (RTS) frame or a data frame.

11. The method of claim 1, wherein the PPDU is transmitted as part of a control frame which is an initial control frame or a control response frame that triggers a peer station (STA) to wake up and switch from a low power mode to an active mode or from a low capability mode to a high capability mode.

12. The method of claim 11, responsive to the performing of the wireless communication comprising receiving and processing the PPDU, further comprising:
switching from the low power mode to the active mode or from the low capability mode to the high capability mode,
wherein the post-FCS padding provides time to carry out the switching.

13. The method of claim 1, wherein the PPDU is transmitted as part of a control frame which is an initial control frame or a control response frame that triggers a peer station (STA) to switch between different links or different subbands.

14. The method of claim 13, responsive to the performing of the wireless communication comprising receiving and processing the PPDU, further comprising:
switching between the different links or the different subbands,
wherein the post-FCS padding provides time to carry out the switching.

15. The method of claim 1, wherein the PPDU is transmitted as part of a control frame that allows a station (STA) obtaining a transmission opportunity (TXOP) to allow itself to switch from a low power mode to an active mode or from a low capability mode to a high capability mode.

16. The method of claim 15, responsive to the performing of the wireless communication comprising generating and transmitting the PPDU, further comprising:
switching from the low power mode to the active mode or from the low capability mode to the high capability mode,
wherein the post-FCS padding provides time to carry out the switching.

17. The method of claim 1, wherein the PPDU is transmitted as part of a control frame that allows a station (STA) and its peer STAs to reconfigure one or more radios or communicate by one or more other radios with respect to an in-device coexistence (IDC) purpose.

18. The method of claim 17, further comprising:
reconfiguring the one or more radios or communicating by the one or more other radios with respect to the IDC purpose,
wherein the post-FCS padding provides time to carry out the reconfiguring or communicating.

19. An apparatus implementable in a responder, comprising:
a transceiver configured to communicate wirelessly; and
a processor coupled to the transceiver and configured to perform operations comprising:
performing, via the transceiver, a wireless communication by:
generating and transmitting a physical-layer protocol data unit (PPDU); or
receiving and processing the PPDU,
wherein the PPDU comprises post-frame check sequence (post-FCS) padding after a frame check sequence (FCS) field of the PPDU.

20. The apparatus of claim 19, wherein the post-FCS padding comprises a padding of a dummy pattern or information useful to a recipient of the PPDU, or both, padded after the FCS field.
